(19) United States
(12) Patent Application Publication
(10) Pub. No.: US 2017/0172126 A1
(43) Pub. Date: Jun. 22, 2017

(54) FISHING USING SONIC-VISUAL STIMULATORS METHOD

(71) Applicant: Bayou Rattler Products, LLC, Houston, TX (US)

(72) Inventors: James Jackson Crisp, Rapid City, SD (US); Calvin Malone, SR., Pineville, LA (US); Shelby LaCroix, JR., Houston, TX (US); Michal Peichl, Houston, TX (US)

(21) Appl. No.: 15/074,345

(22) Filed: Mar. 18, 2016

Related U.S. Application Data
(63) Continuation of application No. 14/978,950, filed on Dec. 22, 2015.

(51) Int. Cl. A01K 85/01; A01K 85/08

(52) U.S. Cl. CPC A01K 85/01; A01K 85/08

(57) ABSTRACT

A method of fishing using various sonic-visual stimulators providing sound-and-visual-interest-generating attachments, generating sound and visual patterns attractive to fish, for use with terminal tackle on a fishing line ahead of a fishing hook or lure, of providing various sonic-visual stimulators having different characteristics, and of providing quick changes of sonic-visual stimulators or combinations of sonic-visual stimulators, and changes of mounting positions relative to other terminal tackle, while fishing, to achieve the most advantageous sonic and visual stimulation under varied, changing, and unpredictable fishing conditions.

### CROSS-REFERENCE TO RELATED APPLICATIONS

This application claims the benefit of pending nonprovisional U.S. application Ser. No. 14/978,950 for a “FISHING-LURE ENHANCED RATTLE APPARATUS AND METHOD,” filed Dec. 22, 2015.

### BACKGROUND OF THE INVENTION

This invention provides a method of fishing using sonic-visual stimulators providing sound-and-visual-interest-generating attachments, generating sound and visual patterns attractive to fish, for use with terminal tackle on a fishing line ahead of a fishing hook.

The addition to fishing lures or fishing hooks of features that are attractive to fish increase the likelihood of catching such fish. In general, sound patterns and visual patterns that mimic something that the fish likes to eat, or that somehow stimulate a similar response, are desirable. The characteristics of sound and light under water, and the characteristics of fish hearing and fish sight, are important considerations in adding such fish-attracting features.

Wide variations in weather conditions, tidal conditions, season, climate, water temperature, time of day or night, vegetation, bottom surface, type of waterway, type of fish sought, and type of bait or lure used call for the use of different types and different intensities of sound patterns and visual patterns to achieve an optimum effect. Also, variations among anglers, such as roughness or smoothness of movement and faster or slower pace of movement, will influence the effectiveness and therefore the choice of any particular sonic or visual feature.

Fishing generally takes place in locations remote from any workshop or storeroom, which limits the amount of tackle that can be transported and be accessible during fishing. But fishing also requires an ability to adapt to varied, changing, and even unexpected conditions, using only what is available in a tackle box, with no realistic opportunity to access any additional tackle. Depending upon such factors as familiarity with a particular fishing spot and fishing conditions, an angler might need to try several different sonic and visual stimulators or combinations of stimulators in order to determine the optimum to use.

The existing methods of adding sonic and visual features to fishing hooks and lures fail to provide an ability to adapt to varied, changing, or unexpected fishing conditions while fishing. There is a need for a method of using the most advantageous sonic and visual stimulator or stimulators, mounted at the most advantageous location relative to the other terminal tackle, for whatever fishing conditions are encountered, including an ability to make quick changes and try different configurations.

### SUMMARY OF THE INVENTION

The present invention provides a method of fishing using various sonic-visual stimulators providing sound-and-visual-interest-generating attachments, generating sound and visual patterns attractive to fish, for use with terminal tackle on a fishing line ahead of a fishing hook or lure, of providing various sonic-visual stimulators having different characteristics, and of providing quick changes of sonic-visual stimulators or combinations of sonic-visual stimulators, and changes of mounting positions relative to other terminal tackle, while fishing, to achieve the most advantageous sonic and visual stimulation under varied, changing, and unpredictable fishing conditions.

### BRIEF DESCRIPTION OF DRAWINGS

Reference will now be made to the drawings, wherein like parts are designated by like numerals, and wherein:

FIG. 1 is an illustration of an embodiment of the fishing using sonic-visual stimulators invention in use with a Texas rig fishing lure;

FIG. 2 is an illustration of an embodiment of the fishing using sonic-visual stimulators invention in use with a Carolina rig fishing lure;

FIG. 3 is an illustration of an embodiment of the fishing using sonic-visual stimulators invention in use inside a fishing lure;

FIG. 4 is an illustration of an embodiment of the fishing using sonic-visual stimulators invention in use with a skirted fishing lure;

FIG. 5 is an illustration of an embodiment of the fishing using sonic-visual stimulators invention in use with a blade fishing lure;

FIG. 6 is an illustration of an embodiment of the fishing using sonic-visual stimulators invention in use with a fishing hook;

FIG. 7 is an illustration of an embodiment of the fishing using sonic-visual stimulators invention in use with another fishing hook;

FIG. 8 is an illustration of an embodiment of the fishing using sonic-visual stimulators invention in use with a barrel swivel;

FIG. 9 is an illustration of an embodiment of the fishing using sonic-visual stimulators invention in use outside a weight;

FIG. 10 is an illustration of an embodiment of the fishing using sonic-visual stimulators invention in use inside a weight;

FIG. 11 is an illustration of an embodiment of the fishing using sonic-visual stimulators invention in use with a snap;

FIG. 12 is an illustration of an embodiment of the fishing using sonic-visual stimulators invention in use with a fishing fly; and

FIG. 13 is an illustration of embodiments of the fishing using sonic-visual stimulators invention using sonic generators having a glowing or luminescent surface, a glitter surface, a metal flake surface, and a multi-colored surface.

### DETAILED DESCRIPTION OF THE INVENTION

Referring to all figures generally, embodiments of the fishing using sonic-visual stimulators method 100 are illustrated. One or more stimulators 10 is placed on or near the fishing hook. Placement near the fishing hook can be on the fishing line, the leader, swivel, snap, or weight. Where the fishing hook is incorporated into a fishing lure, the stimulators 10 can be placed near the lure, or on or within the lure.

The stimulators 10 generate a rattling or other sound pattern attractive to fish. Generally, they have an outer shell encompassing smaller objects or constructed features which together generate the sound.

The stimulators 10 also provide visual patterns, utilizing either reflected light or self-generated light such as luminescent or glow-in-the-dark light, electric light, or chemical-reaction light. Any given visual pattern might be attractive to fish because it mimics something the fish eat, because a color, tint, or shade is inherently highly visible, because adjacently placed combinations of colors, tints, or shades are highly visible, or for a combination of reasons.

The attractiveness and effectiveness of any particular sonic pattern or visual pattern will vary depending on variations in weather conditions, tidal conditions, season, climate, water temperature, time of day or night, vegetation, bottom surface, type of waterway, type of fish sought, type of bait or lure used, and variations among anglers, such as roughness or smoothness of movement and faster or slower pace of movement. This invention provides a variety of sonic-visual stimulators generating a variety of sonic and visual patterns, mountable at various positions relative to the fishing hook or lure and other terminal tackle, which allows the choice and use of the optimum sonic-visual stimulator or combination of stimulators for particular fishing conditions. This invention also provides the quick attachment, removal, relocation, and interchanging of sonic-visual stimulators, while fishing, allowing adaption to varied, changing, and unpredictable fishing conditions.

Several embodiments of the invention, in use for various fishing conditions and with various types of terminal tackle, are illustrated in the figures.

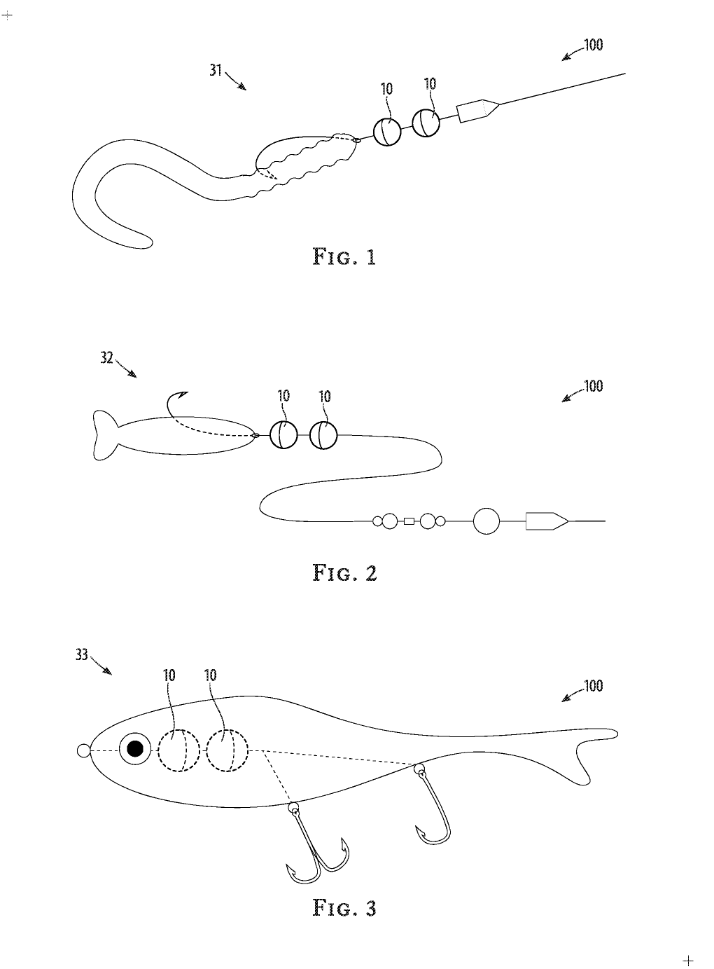

FIG. 1 illustrates two stimulators 10 placed on the fishing line or leader ahead of a Texas rig fishing lure 31.

FIG. 2, illustrates two stimulators 10 placed on the fishing line or leader ahead of a Carolina rig fishing lure 32.

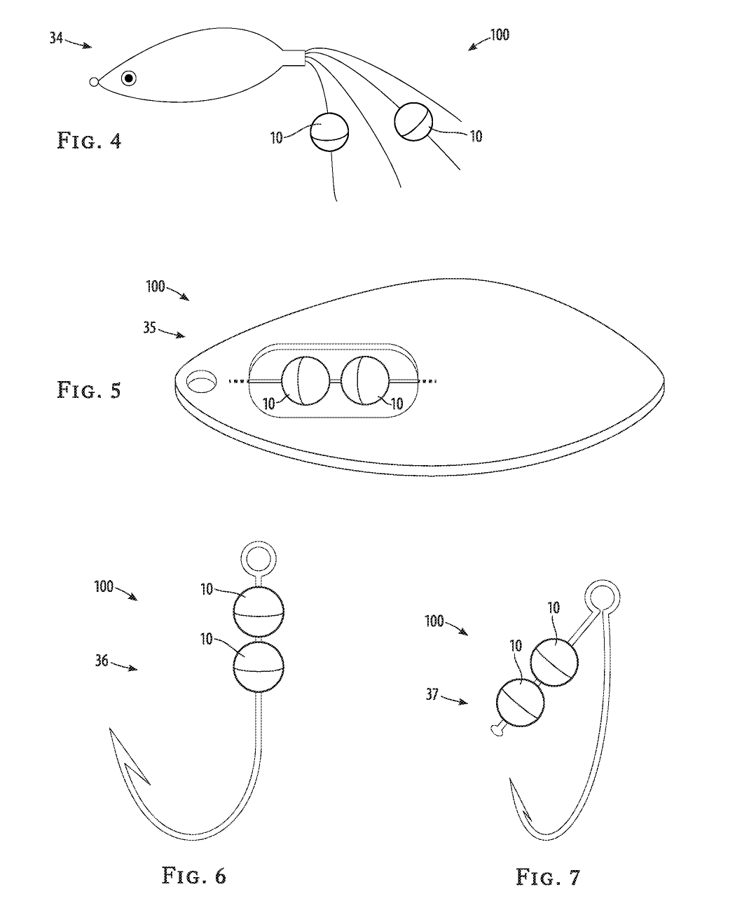

FIG. 3 illustrates two stimulators 10 placed inside a fishing lure 33, which can be soft-surfaced or hard-surfaced.

FIG. 4 illustrates two stimulators 10 placed on the skirts of a fishing lure 34.

FIG. 5 illustrates two stimulators 10 manufactured into a blade fishing lure 35.

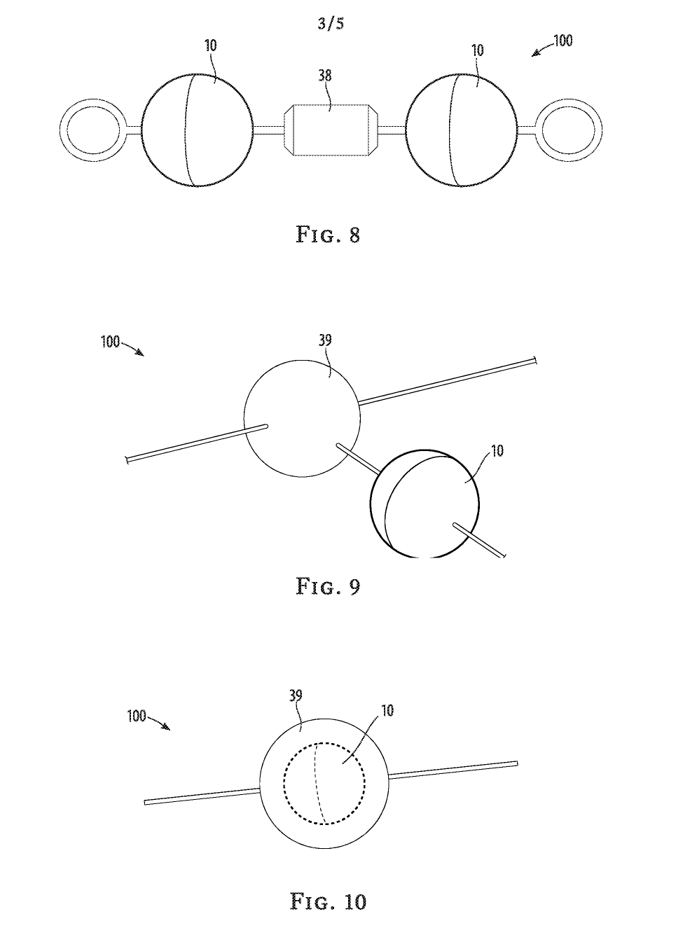

FIG. 6 illustrates two stimulators 10 placed on a standard fish hook 36.

FIG. 7 illustrates two stimulators 10 placed on an anti-fouling projection 37 of a fish hook.

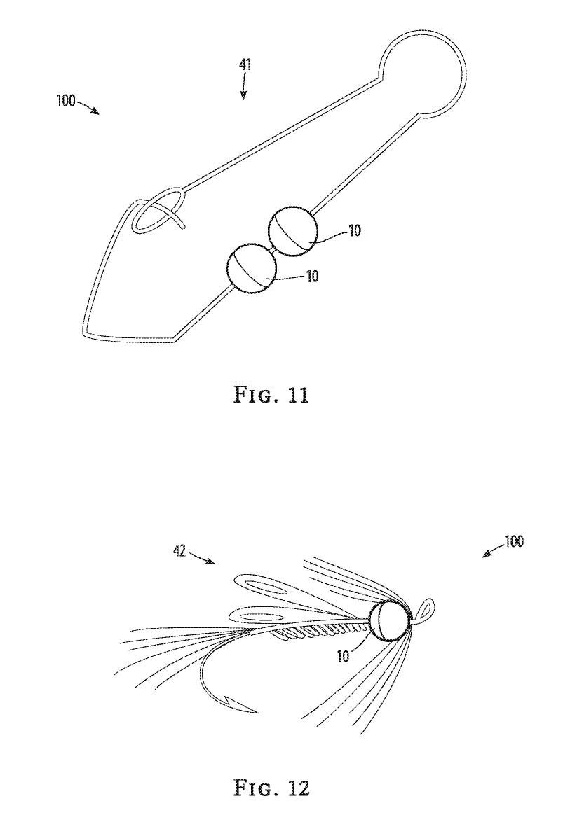

FIG. 8 illustrates two stimulators 10 placed one on each side of a barrel spinner 38.

FIG. 9 illustrates a stimulator 10 placed on the outside of a weight 39 by attachment to a side projection from the weight.

FIG. 10 illustrates a stimulator 10 placed on the inside of a weight 39.

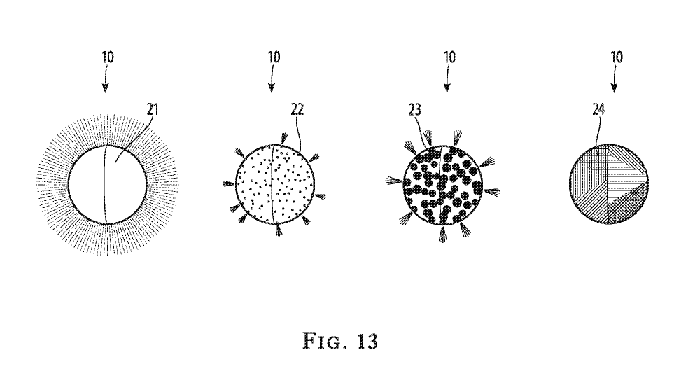

FIG. 11 illustrates two stimulators 10 placed on a snap 41.

FIG. 12 illustrates a stimulator 10 placed on a fishing fly 42.

FIG. 13 illustrates some of the variety of surface treatments that can be provided on the stimulators 10 to enhance visibility and visual stimulation. The surface can be luminescent 21 or glow-in-the-dark. The surface can have applied glitter 22 or reflective flakes 23, such as metallic flakes, to catch light from several directions and reflect the light in several directions. And a multi-colored surface 24 can be used to take advantage of stimulating visual effects from adjacent placement of different colors, tones, or shades.

Many changes and modifications can be made in the present invention without departing from the spirit thereof. I therefore pray that my rights to the present invention be limited only by the scope of the appended claims.

1. A method of fishing using sonic-visual stimulators, comprising:
(i) providing at least one sonic-visual stimulator attachment generating sound and visual patterns attractive to fish;
(ii) attaching said at least one sonic-visual stimulator attachment on or near a fishing hook or fishing lure, resulting in a hook-lure-stimulator assembly; and
(iii) using said hook-lure-stimulator assembly as a component of terminal tackle for fishing,
wherein using said at least one sonic-visual stimulator attachment generates sound patterns and visual patterns attractive to fish, increasing the chance of catching such a fish; and
wherein said at least one sonic-visual stimulator attachment can be quickly attached, removed, repositioned or interchanged with another said at least one sonic-visual stimulator attachment, while fishing.

2. The fishing using sonic-visual stimulators method of claim 1, where said sonic-visual stimulator further comprises a resonant shell adapted to yield sound patterns.

3. The fishing using sonic-visual stimulators method of claim 1, where said sonic-visual stimulator further comprises at least one resonant bead adapted to yield sound patterns upon making intermittent and repeating resonant contact with a resonant shell.

4. The fishing using sonic-visual stimulators method of claim 1, where said sonic-visual stimulator further comprises at least two resonant beads adapted to yield sound patterns upon making intermittent and repeating resonant contact with a resonant shell, and with each other.

5. The fishing using sonic-visual stimulators method of claim 1, where said sonic-visual stimulators further comprise a luminescent exterior surface.

6. The fishing using sonic-visual stimulators method of claim 1, where said sonic-visual stimulators further comprise a reflective exterior surface.

7. The fishing using sonic-visual stimulators method of claim 1, where said sonic-visual stimulators further comprise a multi-colored exterior surface.

8. The fishing using sonic-visual stimulators method of claim 1, where said sonic-visual stimulators further comprise an exterior surface of glitter.

9. The fishing using sonic-visual stimulators method of claim 1, where said sonic-visual stimulators further comprise an exterior surface of metal flakes.

10. The fishing using sonic-visual stimulators method of claim 1, where said sonic-visual stimulators are made from plastic materials.

11. The fishing using sonic-visual stimulators method of claim 1, where said sonic-visual stimulators are made from metal materials.

12. The fishing using sonic-visual stimulators method of claim 1, where said sonic-visual stimulators are placed near a fishing lure.

13. The fishing using sonic-visual stimulators method of claim 12, where said sonic-visual stimulators are placed within a fishing lure.

14. The fishing using sonic-visual stimulators method of claim 12, where said sonic-visual stimulators are placed on a swivel.

15. The fishing using sonic-visual stimulators method of claim 12, where said sonic-visual stimulators are placed on a snap.

16. The fishing using sonic-visual stimulators method of claim 12, where said sonic-visual stimulators are placed on a skirt of a fishing lure.

17. The fishing using sonic-visual stimulators method of claim 12, where said sonic-visual stimulators are placed within a weight.

18. The fishing using sonic-visual stimulators method of claim 12, where said sonic-visual stimulators are placed within a blade.

19. The fishing using sonic-visual stimulators method of claim 12, where said sonic-visual stimulators are placed on a fishing hook.

20. The fishing using sonic-visual stimulators method of claim 12, where said sonic-visual stimulators are placed on a fishing fly.
